(19) United States
(12) Patent Application Publication
(10) Pub. No.: US 2008/0028898 A1
(43) Pub. Date: Feb. 7, 2008

(54) Torque wrench reversal extension

(75) Inventors: Michael D. Greenberg, Bloomfield, CT (US); Keith E. Charette, Meriden, CT (US)

Correspondence Address: CARLSON, GASKEY & OLDS/PRATT & WHITNEY, 400 WEST MAPLE ROAD, SUITE 350, BIRMINGHAM, MI, 48009, US

(73) Assignee: United Technologies Corporation

(21) Appl. No.: 11/497,767

(22) Filed: Aug. 2, 2006

(51) Int. Cl. B25B 23/16; B25G 1/04

(52) U.S. Cl. 81/177.2

(57) ABSTRACT

An extension tool for a torque wrench has a drive end associated with a fastener and a driven end associated with the torque wrench that face 180° from each other. The drive end defines an axis of rotation and the driven end is co-axial with the axis of rotation, which eliminates the need for any type of torque correction due to a change in moment arm length. The extension tool also includes a hand support that allows an installer to apply a load in a direction along the axis of rotation as the torque wrench drives the fastener into place.

### BACKGROUND OF THE INVENTION

This application relates to a torque wrench extension tool that reverses a direction of drive while eliminating the need for torque corrections due to offset.

Torque wrenches are used to install fasteners to predetermined torque levels, such that the fasteners are not too loose (under-torqued) or too tight (over-torqued). A female socket is attached to one end of the wrench and is appropriately sized for coupling with the fastener. The torque wrench also includes a dial that can be read by an installer so that the installer knows when the predetermined torque level has been reached. The socket is installed over the fastener, and the torque wrench is rotated by the installer until the predetermined torque level is achieved.

In certain applications, such as assembling a gas turbine engine for example, the torque wrench is used to torque bolts located overhead of the installer. This type of assembly can be awkward, and requires reading of the dial looking upwards. Further, this type of assembly often requires the use of an extension tool, which allows the tool direction to be reversed making installation easier. However, using existing extension tools can introduce errors into the torque levels.

One known extension tool is a J adapter that has a straight body portion that transitions into a curved portion to form a J-shape. The straight body portion defines an axis of rotation and has a distal end that receives the socket. The curved portion extends to a distal end that is coupled to the torque wrench. Due to the J-shape, the connection between the tool and the torque wrench is offset from the axis of rotation. This offset requires torque correction due to changes in moment arm length. Requiring correction can further induce error into the torque levels.

Additionally, further error can be introduced into the torque levels if the tool is not properly installed. For example, the tool can be installed in one of three different orientations. The torque wrench has a male connector having a square shape and the tool has a female socket having a corresponding square shape. Thus, due to the square shape there are three different clocking orientations that the male connector can be inserted into the female socket (a fourth clocking orientation is prevented due to the location of the straight body portion of the J adaptor). Each orientation has a different correction factor for the offset. If the torque wrench is installed in an improper orientation a wrong correction factor could be used, which would further introduce error into the torque level.

Thus, there is a need for an extension tool for a torque wrench that does not require torque correction, and which can easily and effectively be installed onto a torque wrench.

### SUMMARY OF THE INVENTION

In a disclosed embodiment of this invention, an extension tool for a torque wrench has drive and driven ends that rotate together about a common axis of rotation. The drive end is associated with a fastener and the driven end is associated with the torque wrench. The drive end defines the axis of rotation and the driven end is co-axial with the axis of rotation. This eliminates the need for any type of torque correction. Another benefit is that the torque wrench can be coupled to the extension tool in any clocking orientation without introducing any further error.

In one example embodiment, the extension tool includes a hand support that allows an installer to apply a load in a direction along the axis of rotation as the torque wrench drives the fastener into place.

These and other features of the present invention can be best understood from the following specification and drawings, the following of which is a brief description.

### BRIEF DESCRIPTION OF THE DRAWINGS

FIG. 1 is a prior art extension tool for a torque wrench.

FIG. 2 is one example of an extension tool for a torque wrench, which incorporates the subject invention.

### DETAILED DESCRIPTION OF THE PREFERRED EMBODIMENT

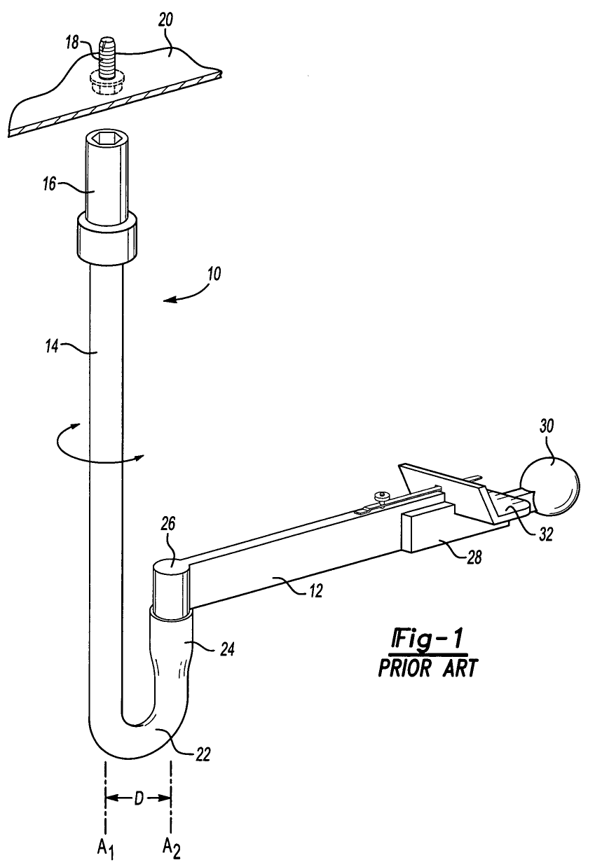

FIG. 1 shows an extension tool 10 for a torque wrench 12 designed according to the prior art. The extension tool 10 has a J-shape with a straight portion 14 extending to a drive end, which supports a socket 16 that cooperates with a fastener 18. The straight portion 14 defines an axis of rotation A1 about which the straight portion 14 rotates as the fastener 18 is driven into a structure 20.

The straight portion 14 transitions into a curved portion 22 that extends to a driven end 24 that connects to the torque wrench 12. The driven end 24 defines a second axis A2. The torque wrench 12 includes a first end 26 that couples to the driven end 24 of the extension tool 10 and a second end 28 that includes a knob or handle 30. The torque wrench 12 includes a visual torque dial, or scale 32, which indicates the torque level as known.

The first end 26 of the torque wrench 12 is coupled to the driven end 24 of the extension tool 10. An installer rotates the handle 30, which rotates the torque wrench 12 and the extension tool 10 to drive the fastener 18 into place. As shown, the second axis A2 for the driven end 24 is offset by a distance D from the axis of rotation A1. This offset requires torque level correction to ensure that a desired torque level for the fastener 18 is achieved.

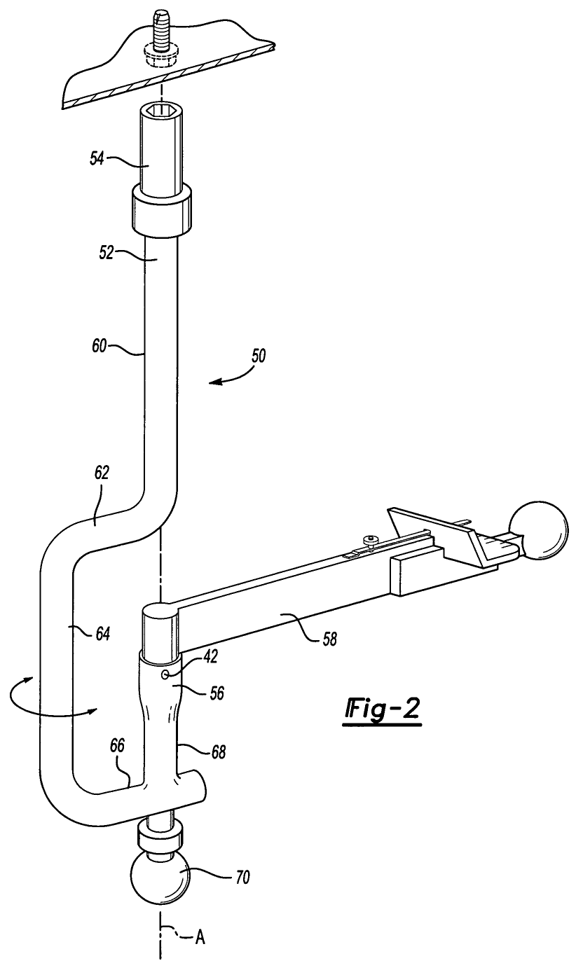

An extension tool 50 incorporating the present invention still reverses drive direction but eliminates the need for this type of torque correction. As shown in FIG. 2, the extension tool 50 includes a drive end 52 that is adapted to receive a socket 54 for driving a fastener into place. An optional spring-loaded locking pin or similar retention mechanism can be used to prevent the socket 54 from falling off. The extension tool 50 also includes a driven end 56 that is driven by a torque wrench 58 where the drive 52 and driven ends 56 are positioned 180° relative to each other. The torque wrench 58 includes a ball, a locking pin, or other similar retention mechanism that may be received within a hole 42 to provide an extra secure connection between the torque wrench 58 and the driven end 56. The torque wrench 58 is configured similarly to the torque wrench 12 described above.

The extension tool 50 has a shape that generally conforms to an upside down question mark shape when used in an overhead application. In one example, the extension tool 50 is formed from a continuously bent piece of material to provide the specified shape. The extension tool 50 includes a first portion 60 that defines an axis of rotation A about which the first portion 60 rotates. The first portion 60 is generally straight and extends along the axis of rotation A. The first portion 60 transitions into a second portion 62 that extends from the first portion 60 in a direction transverse to the axis of rotation A. A third portion 64 extends from the second portion 62 in a direction generally parallel to the axis of rotation A, and transitions into a fourth portion 66. The fourth portion 66 extends from the third portion 64 in a direction transverse to the axis of rotation and transitions into a fifth portion 68. The fifth portion 68 extends from the fourth portion 66 in a direction generally along the axis of rotation A. The first portion 60 extends from the second portion 62 in the same direction that the fifth portion 68 extends from the fourth portion 66.

The drive end 52 and driven end 56 are axially spaced apart from each other along the axis of rotation A. In the example shown, the second portion 62 and the fourth portion 66 are generally perpendicular to the axis of rotation A, such that the second 62, third 64, and fourth 66 portions form a C-shape. Thus, the extension tool 50 is configured such that the drive end 52 and the driven end 56 are co-axial with each other and with the axis of rotation A. As such, the drive end 52 and driven end 56 both rotate together about the axis of rotation A as an installer rotates the torque wrench 58 to drive the fastener into place. This eliminates the need for any type of torque correction, since there is no change in moment arm length, and further allows the torque wrench to be coupled to the extension tool in any clocking orientation without introducing any further error.

In the example shown, the extension tool 50 includes a support member 70 that extends downwardly along the axis of rotation A. The support member 70 comprises a knob, handle, etc., such that an installer can engage the handle with one hand while driving the torque wrench 58 with another hand. The support member 70 can be rigidly fixed to the extension tool 50 or could be rotatably supported by a bearing or bushing assembly (not shown). The support member 70 is coaxial with the axis of rotation A, which allows the installer to apply a load in a direction along the axis of rotation A, which further facilitates installation of the fastener.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An extension tool for a torque wrench comprising:
a first body portion defining an axis of rotation and including a first distal end that includes structure for coupling with a fastener; and
a second body portion having a second distal end that includes structure for coupling with a torque wrench wherein said second body portion is coaxial with said first body portion.

2. The extension tool according to claim 1 comprising a third body portion transitioning from said first body portion into said second body portion, said third body portion having a C-shape.

3. The extension tool according to claim 2 wherein said third body portion first extends from said first body portion in a direction transverse to said axis of rotation, then extends in a direction generally parallel to said axis of rotation, and then extends into said second body portion in a direction transverse to said axis of rotation.

4. The extension tool according to claim 3 wherein said first and said second body portions extend from said third body portion in the same direction.

5. The extension tool according to claim 1 including a hand support on said second body portion that allows an installer to apply a load in a direction along said axis of rotation.

6. The extension tool according to claim 5 wherein said hand support comprises a knob that is coaxial with said axis of rotation.

7. The extension tool according to claim 1 wherein said first distal end comprises a drive end and said second distal end comprises a driven end, said drive end and said driven ends being positioned 180° relative to each other.

8. A torque wrench assembly comprising:
a torque wrench including a torque output device identifying corresponding torque levels as said torque wrench installs a fastener; and
an extension tool having a first connection interface cooperating with the fastener and a second connection interface for connection with said torque wrench wherein said first and said second connection interfaces are coaxial to rotate about a common axis.

9. The torque wrench assembly according to claim 8 wherein said extension tool includes a first portion that extends along said common axis, a second portion that extends from said first portion in a direction transverse to said common axis, a third portion that extends from said second portion in a direction generally parallel to said common axis, a fourth portion that extends from said third portion in a direction transverse to said common axis, and a fifth portion that extends from said fourth portion in a direction along said common axis.

10. The torque wrench assembly according to claim 9 wherein said first portion extends to a first end that defines said first connection interface and wherein said fifth portion extends to a second end that defines said second connection interface.

11. The torque wrench assembly according to claim 10 wherein said first and second ends are axially offset from one another along said common axis.

12. The torque wrench assembly according to claim 11 wherein said first portion extends from said second portion in the same direction as said fifth portion extends from said fourth portion.

13. The torque wrench assembly according to claim 9 wherein said second and said fourth portions are generally perpendicular to said common axis.

14. The torque wrench assembly according to claim 8 including a hand support on said extension tool that rotates about said common axis such that an installer can engage said hand support with one hand while driving said torque wrench with another hand.

15. The torque wrench assembly according to claim 14 wherein said hand support is coaxial with said common axis to allow application of a load in a direction along said common axis as the fastener is installed.

16. The torque wrench assembly according to claim 8 wherein said first connection interface includes a positive socket retention device.

17. The torque wrench assembly according to claim 8 wherein said second connection interface includes a hole that accepts a locking device.

18. The torque wrench assembly according to claim 8 wherein said extension tool is formed as a single piece component from a continuously bent piece of material.
